(19) United States
(12) Patent Application Publication
(10) Pub. No.: US 2013/0003150 A1
(43) Pub. Date: Jan. 3, 2013

(54) SECURITY ELEMENT INCLUDING AN OPTICAL STRUCTURE

(75) Inventors: Michel Camus, Rives (FR); Stéphane Mallol, Provins (FR); Ivan Thierry, Jouy Sur Morin (FR); Pierre Doublet, Saint Brice (FR)

(73) Assignee: ARJOWIGGINS SECURITY, BOULOGNE BILLANCOURT (FR)

(21) Appl. No.: 13/515,932

(22) PCT Filed: Dec. 13, 2010
(86) PCT No.: PCT/IB10/55779

§ 371 Date: Sep. 14, 2012

(30) Foreign Application Priority Data
Dec. 14, 2009 (FR) 09 06033

(51) Int. Cl. G03H 1/00

(52) U.S. Cl. 359/2

(57) ABSTRACT

The present invention relates to a security element (1; 30) intended for being added to or on a security document (21; 31), including at least one first optical structure (2) such as a standard rainbow hologram and/or a raster image representing a first pattern (22) and at least one second optical structure (3), which is achromatic and represents a second pattern (23) at least partially identical to the first pattern (21).

The present invention relates to security elements comprising an optical structure, such as optical structures of the standard holography type and/or of the raster image type, which are intended to be introduced into or on security documents.

Generally, a structure exhibiting an optical effect of the standard holography type reproduces an object in relief in the pure colors of the rainbow. Such structures are also known as standard rainbow holograms as they have the property of being able to break up the various wavelengths of white light, which is reflected visually by a colored appearance imitative of a rainbow.

Standard holograms can be obtained by a diffractive optical principle which is classical and known as such. For example, a light beam, such as a laser, is separated into two light rays by diffraction grating. The two rays subsequently follow different optical pathways and one of the rays is reflected by the object to be holographed. The difference in optical pathway bring about a phase separation between the rays which is essential to the process of producing the hologram. Finally, the two phase-separated light rays meet on a photosensitive film to produce interferences which form the standard hologram and are expressed visually by representation of the objects in relief.

Advantageously, the hologram thus produced can constitute a very secure protection system. This is because its design requires equipment and a technique of great sophistication, which makes it possible to combat duplications by conventional printing methods and seriously restricts the risks of forgery. Furthermore, as optically variable element, the hologram is not reproducible by color photocopying; it thus also makes it possible to combat this means of forgery.

For all these reasons, the use of holograms as optical security elements is increasingly widespread in the field of security documents. Furthermore, they are combined with various types of supports, such as paper, security threads, broad foils or strips, labels or laminating films. They can also be incorporated in various types of security documents. Security document denotes, for example, a document of value, a means of payment, such as a bank note, a check or a meal ticket, a lottery ticket, a travel document or a ticket giving access to a cultural or sports event, and/or a document for the identification of people, such as an identity card, a visa, a passport or a driving license.

It is easily understood that it appears essential to guard against attempts at falsification or forgery in the field of security documents. There thus exists a certain need for security elements comprising an optical structure of the standard holography type.

However, the public may have difficulties in visualizing standard holograms due to their rainbow appearance. This is because, for correct visualization, it is necessary to subject the standard hologram to specific illumination or to incline it in different ways in order to understand it in its entirety. The result of these difficulties is that the authentification of the document carrying the standard hologram is not direct and is a source of confusion.

Optical structures of the raster image type, that is to say representing a raster pattern, for example obtained by demetallization, have to be observed with particular attention in order to be recognized by the public. To combine such a raster image with an element which is readily visible and recognizable would result in the public more carefully examining the raster image, resulting in counterfeit imitations being recognized.

The aim of the invention is thus to provide a security element comprising an optical structure of the standard holography type and/or of the raster image type for documents such as described above which makes possible an authentification of the document by the public which is simultaneously simple, reliable and fast.

To this end, the subject matter of the invention is a security element intended to be incorporated in or on a security document, comprising at least one first optical structure of the standard rainbow holography type and/or of the raster image type representing a first pattern and at least one second optical structure which is achromatic and represents a second pattern at least partially identical to the first pattern.

An achromatic optical structure, in contrast to a standard rainbow holographic structure, does not break up white light. It is visible under different inclinations and even when it is illuminated by low intensity light. Its contrast and its sharpness remain entirely satisfactory under different illuminations. It thus constitutes an excellent reference pattern easily identifiable by the public.

An achromatic optical structure does not require particular attention in order to be recognized by the public; it is directly identifiable. It thus also constitutes an excellent reference pattern in combination with an optical structure of the raster image type. The second achromatic optical structure can thus advantageously be distinct from an optical structure of the raster image type, which makes it possible to rapidly and simply recognize it, in comparison with the first optical structure. A simple raster image corresponds to a halftone image or a binary image, that is to say that there are two shades to the image, for example black and white, or, in the case of selective metallization of the surface of the optical structure, the two shades of the image are, in a first region, the metallization and, in a second region, the absence of metallization.

Furthermore, a more complex, that is to say multitone, raster image can, for example, be obtained by a frequency modulation or amplitude modulation rastering method.

According to these respective processes, the size of the raster points varies as a function of the optical density to be reproduced or the size of the raster points is constant but the separation varies as a function of the optical density to be reproduced.

The resolution of the raster image can be between 200 and 2500 dpi.

The raster image can comprise an assembly of points and/or lines, which may or may not be parallel, for which the size and/or the spacing between them are variable or constant, this assembly forming a succession of light and dark regions, for example white and black regions. The raster points can have a circular shape and can all have the same dimensions or dimensions which vary between them. The highly advantageous use of an achromatic optical structure, in particular the combination according to the invention of one and the same pattern represented, on the one hand, in standard rainbow holography and/or as a raster image and, on the other hand, in achromatic optics, allows the public, by simultaneous observation, to compare the two representations, to identify the pattern and thus to authenticate the security document.

Furthermore, each of the optical structures contributes it own level of security, which makes it even more difficult to falsify the document and makes it possible to more effectively combat acts of forgery.

According to a specific embodiment of the invention, the first structure comprises a structure of the standard rainbow holography type which is an optically variable diffractive structure.

According to a specific embodiment of the invention, said first optical structure comprises a raster image which comprises a plurality of points representing said first pattern, for example in three dimensions. Preferably, the points of the structure of the raster image type are obtained by perforation, deposition and/or voids of material. For example, the points of the raster image are obtained by metallization or demetallization of materials selected from:

metals, metal compounds, alloys, metal varnishes or metal inks, such as is described in the document EP 0 279 880. Alternatively, the points of the structure of the raster image type can be obtained by selective printing, in positive or negative, of an ink comprising pigments chosen from: carbon black pigments, magnetic pigments, colored pigments, pigments visible under UV or IR radiation or a mixture of the latter. The points of the raster image can have variable shapes and/or dimensions and can also be distributed in a variable fashion, so as to form a multitone pattern.

It is also possible to rasterize in a different fashion several regions of the image and in particular, when use is made of raster points consisting of lines, it is possible to reproduce some parts of the image with lines having a given inclination and other parts of the image with lines having a different inclination. It is thus possible to have, within the same raster image, several regions, for example three or four, the raster points of which are composed of lines having different orientations.

According to another specific embodiment of the invention, the second optical structure is an achromatic structure reproducing the second pattern in three dimensions.

According to a specific embodiment of the invention, the first structure and the second structure are positioned on the security element in an adjacent fashion or are separated by a distance of less than seven centimeters, so as to be observable simultaneously and to be able to be compared.

The first optical structure and the second optical structure can have at least a portion of their outline which is identical. In particular, the first pattern and the second pattern can have at least a portion of their outline which is identical.

The security element according to the invention can additionally comprise the following distinctive features:
at least one layer of protective varnish on one of its faces,
at least one layer of hot melt adhesive or cold-seal adhesive or a self-adhesive.

The invention applies to a security support composed of natural fibrous materials, for example of cellulose and/or of cotton, and/or of synthetic fibers, comprising at least one security element.

In the security support according to the invention, the security element can exist in the form of a thread which is at least partially incorporated in the support with the at least partially visible first and second optical structures. In this case, the security element is preferably substantially transparent or translucent in the regions covered by the support, so that the patterns are visible in transmitted light. Alternatively, the security element can exist in the form of a strip or of a patch applied to a surface of the support. For example, such a security strip exhibits a width of between 6 and 20 mm.

The invention also applies to a security document, such as a passport, an identity card, a driving license, an interactive trading card, a means of payment, in particular a credit card, a voucher, a travel pass, a loyalty card, a provision card or a season ticket, including a security element which comprises at least one first optical structure of the standard rainbow holography type and/or of the raster image type representing a first pattern and at least one second optical structure which is achromatic and represents a second pattern at least partially identical to the first pattern.

Implementational examples of security elements according to the invention are described in more detail below and are illustrated in the figures. This description is given only by way of indicative example and is in no way limiting of the invention.

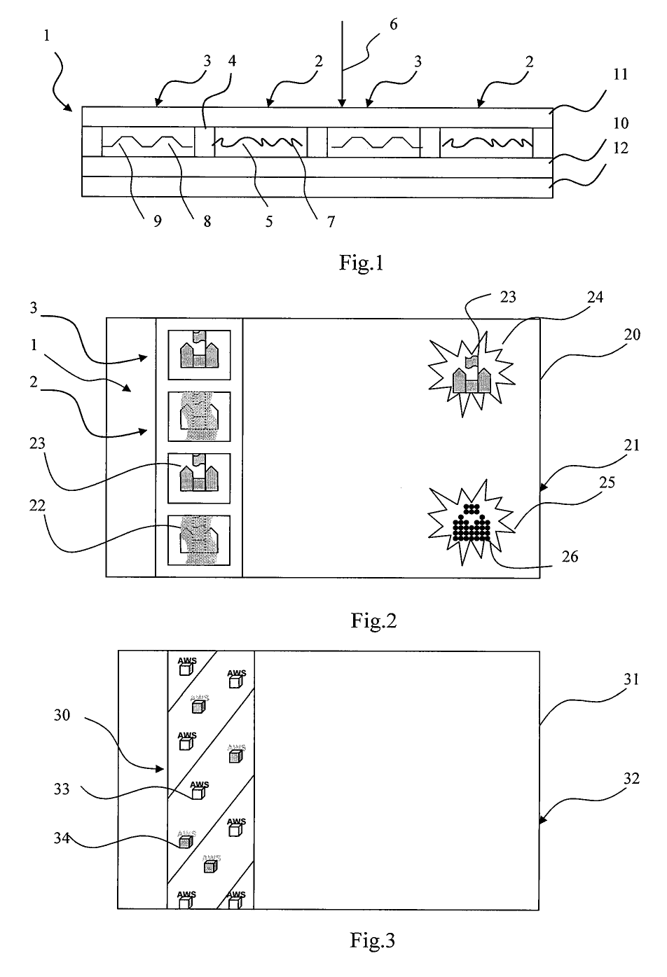

FIG. 1 illustrates a security element according to a first embodiment of the invention, seen in transverse cross section.

FIG. 2 illustrates a document equipped with the security element shown in FIG. 1.

FIG. 3 illustrates a document equipped with a security element according to a second embodiment of the invention.

In FIG. 1, the security element 1 intended to be incorporated in or on a security document is shown.

In the implementational example of FIG. 1, the security element 1 is a strip of elongated shape, known under the name of “security foil” in the field of security documents. Its width is preferably between 6 and 20 mm and its thickness is preferably approximately 5 microns.

In particular, the security element 1 comprises an alternation of first optical structures 2 of the standard rainbow holography type and of second optical structures 3 which are achromatic. The optical structures 2 and 3 are positioned in the same plane, on the same face of the security element 1, close to one another along the security element 1 with a space 4 which separates a first optical structure of the standard rainbow holography type 2 from an achromatic optical structure 3.

The optical structure 2 of the standard rainbow holography type is, for example, obtained by embossing with a laser or by means of an electron beam, or by microstamping a plastic layer 5, such as polyester, PVC, acetate or polyethylene, inter alia. The optical structure 2 thus exhibits microreliefs corresponding to the diffractive grating of the hologram of the rainbow type. Alternatively, the microreliefs are obtained by hot stamping a thermoplastic layer or alternatively by microetching. This optical structure 2 is subsequently subjected to a surface treatment so as to form a metal layer 7 matching the microreliefs. For example, the metal layer 7 is reflective and obtained by vaporization of aluminum over the plastic layer 5. Other materials can be chosen from the following list: copper, tin, chromium, silver, gold, nickel or appropriate alloys, such as stainless steel, metal inks or also metal oxides.

Provision may also be made for the metal layer to be applied partially or selectively according to the regions so as to form complementary patterns or another optical structure of the raster image type. It is also envisaged to obtain these complementary patterns by any other demetallization process. The complementary patterns can be marks, alphanumeric characters or symbols, inter alia.

The optical structure 2 constitutes an optically variable arrangement which exists in the form of a hologram with a visual effect of the rainbow type.

The achromatic optical structure 3 is, for example, obtained from a tin part which is etched so that it reproduces the corresponding reliefs of the pattern which it is desired to represent. In this sense, it is regarded as a relief hologram of achromatic type.

Alternatively, an image of the pattern can be desaturated by a computer method and a reconstruction in three dimensions (3D) is produced from this desaturated image. The term “to desaturate” is understood to mean to remove the color from the image. In particular, the image can be completely desaturated, that is to say can be in levels of gray.

Another method consists in producing a 3D acquisition of a volume representing the pattern, in subdividing the pattern into equidistant slices in the plane of the pattern, and in suppressing the portions of slices which exhibit a uniform thickness in order to obtain a thin sheet in the manner of a Fresnel lens. For example, a process of nanometric etching by an electron beam subsequently makes it possible to reproduce the pattern on a support. This method is particularly suitable for obtaining an achromatic optical structure reproducing a pattern in three dimensions while being substantially flat.

Yet another method for producing an achromatic optical structure is described in the document US 2005/0270604. This method is based on the superimposition of holographic layers of the rainbow type in order to produce an achromatic effect.

The relief reproducing the 3D pattern obtained by one of the processes below is preferably formed in a plastic layer 8, such as polyester, PVC, acetate or polyethylene, inter alia. Alternatively, the relief is obtained by hot stamping a thermoplastic layer. The layer 8 is subsequently subjected to a surface treatment in order to form a metal layer 9 matching the relief.

Any type of process suitable for producing an achromatic optical structure reproducing the 3D pattern can be used without departing from the scope of the invention.

Provision is also made, according to the invention, for the metal layer 7 of the optical structures 2 of the standard holography type and the metal layer 9 of the achromatic optical structures 3 are each produced from a different metal material. For example, the metal layer 7 is composed of a metal film based on aluminum and the metal layer 9 is composed of a metal film based on copper, so that the two metals exhibit different colors. This arrangement has the effect of reinforcing the distinction between the two optical structures 2 and 3 in order to facilitate the comparison thereof and thus the authentification of the document. In addition, the use of different metal materials on one and the same security element makes it even more difficult to falsify the document.

The optical structures 2 and 3 can subsequently be subjected to another surface treatment so as to form, for example, a first 10 and a second 11 layer of protective varnish on each side of the strip. Thus, the two faces of the optical structures 2 and 3 are sandwiched and protected between the layers 10 and 11, in particular against abrasion but also against electroforming.

Furthermore, a layer of adhesive 12, for example hot-melt adhesive, is coated on the face of the security element 1 which is intended to come into contact with the security document. It is understood that the relief obtained for each optical structure has to be visible on the opposite face of the security element 1, that is to say in the direction indicated by the arrow 6.

A relatively rigid and removable support layer may also equip the security element 1, so that the security element is not damaged during transportation and up to its incorporation into the security document

In the security element 1 described above, the distance between two adjacent optical structures 2 and 3 is preferably less than 7 cm in order for these two structures to be observable simultaneously. The optical structure 2 of the standard rainbow holography type can be adjacent to the achromatic optical structure 3, or substantially adjacent, that is to say positioned close by with a reduced space 4 separating them, as illustrated in FIGS. 1 and 2. The optical structures can also be positioned on the strip security element 1 according to a particular distribution, as illustrated in FIG. 3.

Consequently, with the arrangement according to the invention, an observer looking at the security element 1, in the direction indicated by the arrow 6, thus simultaneously sees a first rainbow optical structure 2 and an achromatic optical structure 3, the patterns of which he can compare under different angles and illuminations. This visual comparison makes the authentification of the document obvious.

In FIG. 2, the security element 1 as described with reference to FIG. 1 is shown, which is positioned conventionally on a support 20 by means of the adhesive layer 12 in order to form the security document 21. For example, the security element 1 is applied transversely on the support 20 by a hot press or by a lamination transfer.

As illustrated in FIG. 2, the patterns 22 and 23, respectively formed by the first optical structure 2 and the second optical structure 3, are at least partially alike and preferably identical. The term “partially alike” or “partially identical” is understood to mean the fact that two patterns include recognizable parts, lines or shapes which are identical or similar and which are sufficient for the public to associate the two patterns. In the example illustrated in FIG. 2, apart from the rainbow and achromatic visual aspect, the observer notices that the patterns 22 and 23 are identical. In the example, they represent a castle but any other pattern easily recognizable by the public can be represented without departing from the present invention. For example, the face of a celebrity, a known monument or another pattern can be provided.

In FIG. 2, the security document 21 is also shown equipped with two patches 24 and 25 positioned in corners of the document 21. In the implementational example of FIG. 2, the patch 24 carries an optical structure of the rainbow hologram type representing the pattern 23 identical to the pattern 22 of the optical structure 2 of the standard rainbow holography type.

The patch 25 carries an optical structure of the raster image type 26 as defined above. As illustrated, the raster image 26 comprises a plurality of points representing the first pattern 22 in a manner recognizable to the public. Preferably, the points of the structure of the raster image type are obtained by perforation, deposition and/or voids of material, for example by a metallization or a demetallization.

According to the invention, the support 20 of the document 21 comprises translucent or transparent regions at least located at the optical structure of raster image type 26 so that, in the case of an image obtained by demetallization, for example, the corresponding pattern is visible in transmitted light. In this case, the optical structure of raster image type 26 is visible during observation in transmitted light, whereas the optical structures of the rainbow holography type and the achromatic optical structures are visible in reflected light, which makes the falsification of the document even more difficult. Furthermore, the raster image can present a pattern in three dimensions when it is viewed in transmitted light. Such a security element with an optical structure of raster image type is described in document EP 1 674 286.

According to the invention, the patches 24 and 25 are positioned close to one another, preferably at a distance of less than seven centimeters, so that an observer simultaneously sees the two patches 24 and 25, the patterns of which he can compare under different angles and illuminations in order to authenticate the document.

It is understood that it would not be departing from the invention to equip the security document 21 with a strip security element 1 comprising an alternation of first optical structures of the raster image type and of second optical structures which are achromatic or an alternation of optical structures of the rainbow hologram type, of optical structures of the raster image type and of optical structures which are achromatic.

Alternatively, the patches can themselves each carry an optical structure of the rainbow hologram type and an achromatic optical structure representing the same pattern and/or an optical structure of the raster image type and an achromatic optical structure.

A security element 30, which is also provided in the form of an elongated strip, has been represented in FIG. 3. This security element 30 is also attached to a security support 31 to form a security document 32.

The security element 30 comprises first optical structures 33 of the rainbow hologram type and second achromatic optical structures 34 which are positioned on the security element with an alternation which is both longitudinal and transversal. As illustrated in FIG. 3, each rainbow optical structure 33 is juxtaposed with an achromatic optical structure 34, this being done in both directions of the plane defined by the security element 30.

In this embodiment, the pattern represented by the optical structures 33 and 34 is a 3D cube above which is placed the inscription AWS, obtained in positive, in negative or by demetallization.

In both embodiments described with reference to FIGS. 2 and 3, the security element can be transferred onto the support with a formation of an excessive thickness or by means of the method described in the document WO 2009/022072. This document describes the manufacture of a paper support from two fibrous jets being formed in round forms and intended to be deposited on one another. One of the fibrous jets comprises an elongated region of zero thickness intended to receive the security strip without generating an excessive thickness.

According to the invention, the security element 30 can also include optical structures of the raster image type as defined above, which represent the same pattern as the achromatic optical structures 34.

Alternatively to the two above embodiments, the security element according to the invention can be provided in the form of a thin tape, commonly known as “security thread”, the width of which generally does not exceed 4 mm and the thickness of which is approximately 20-30 microns. This security thread, generally made of plastic, comprises, in addition to the rainbow optical structures and optical structures of the raster image and achromatic type, security elements, for example luminescent security elements. In addition, the security thread is introduced at least partially in bulk into the support of the security document, and only a portion appears visible, for example, through a plurality of windows formed in the fibrous mass being formed, such as are described in the document EP 0 059 056. The visible portion reveals the rainbow optical structures and achromatic optical structures representing the same pattern.

In a specific embodiment of the invention, the security support carrying the security element is composed of natural fibrous materials, for example of cellulose and/or cotton, and/or synthetic fibers. The security support can also be produced from plastic materials, such as, for example a Polyart™ film sold by Arjobex Ltd.

The security document including the security support and element can be a document such as a passport, an identity card, a driving license, an interactive trading card, a means of payment, in particular a credit card, a voucher, a travel pass, a loyalty card, a provision card or a season ticket.

A security document thus obtained therefore comprises at least one security element as described above which constitutes a “first level” security element. However, it can comprise other “first level” security elements and/or at least one “second level” and/or “third level” security element.

The document can in particular comprise the following security elements, alone or in combination:
luminescent dyes and/or pigments and/or interference pigments and/or liquid crystal pigments, in particular in the printed form or mixed with at least one constituent layer of the document,
components, dyes and/or pigments which are photochromic or thermochromic, in particular in the printed form or mixed with at least one constituent layer of the document,
an ultraviolet (UV) absorber, in particular in the coated form or mixed with at least one constituent layer of the document,
a specific light-collecting material, for example of the “wave guide” type, for example a material which collects luminescent light, such as polycarbonate-based polymer films sold by Bayer under the LISA® name,
a multilayer interference film,
a structure having a variable optical effect based on interference pigments or liquid crystal pigments,
a birefringent or polarizing layer,
a diffraction structure,
an embossed image,
means producing a “moire effect”, it being possible for such an effect, for example, to reveal a pattern produced by the superimposition of two security elements on the document, for example by bringing together lines of two security elements,
a partially reflecting refractive element,
a transparent lenticular grating,
a lens, for example a magnifying glass,
a colored filter,
another goniochromatic or holographic metalized foil,
a layer having a variable optical effect based on interference pigments or liquid crystal pigments,
a flat security element having a relatively small size, such as a small board, which is visible or invisible, in particular luminescent, with or without an electronic device,
particles or agglomerates of particles of pigments or dyes of HI-LITE type, which are visible or invisible, in particular luminescent,
security fibers, which are in particular metallic, magnetic (having soft and/or hard magnetism), or absorbent, or excitable towards ultraviolet radiation, visible light or infrared radiation, and in particular near infrared (NIR) radiation,
an automatically readable security having specific and measurable characteristics of luminescence (for example fluorescence or phosphorescence), of absorption of light (for example ultraviolet, visible or infrared light), of Raman activity, of magnetism, of microwave interaction, of interaction with X-rays or of electrical conductivity.

One or more security elements as defined above can be present in the document and/or in one or more constituent layers of the document or in one or more security elements incorporated in the document and/or in one or more constituent layers of the document, such as, for example, a thread, a fiber or a small board.

One at least of the constituent layers of the document can also comprise a first level security element, such as a watermark or a pseudo-watermark, which is at least partially superimposed with a translucent region of the document

1. A security element for incorporating in or on a security document, the security element comprising:
at least one first optical structure comprising a raster image representing a first pattern,
at least one second optical structure which is achromatic and represents a second pattern at least partially identical to the first pattern.

2. (canceled)

3. The security element as claimed in claim 1, in which the raster image of said first optical structure comprises a plurality of points representing said first pattern.

4. The security element as claimed in claim 1, in which the points of the raster image are obtained by perforation, deposition and/or voids of materials, selected from: metals, metal compounds, alloys, metal varnishes or metal inks.

5. The security element as claimed in claim 1, in which the at least one second optical structure is an achromatic structure reproducing the second pattern in three dimensions.

6. The security element as claimed in claim 1, in which the first optical structure and the second optical structure are positioned on the security element in an adjacent fashion so as to be observable simultaneously and to be able to be compared.

7. The security element as claimed in claim 1, in which the first optical structure and the second optical structure are positioned on the security element and are separated by a distance of less than seven centimeters, so as to be observable simultaneously and to be able to be compared.

8. The security element as claimed in claim 1, in which said at least one first optical structure comprises a first reflecting layer and said at least one second optical structure comprises a second reflecting layer, the reflecting layers being composed of different materials.

9. The security element as claimed in claim 1, said at least one second achromatic optical structure being distinct from raster image.

10. A security support composed of natural fibrous materials, and/or of synthetic fibers, comprising at least one security element as claimed in claim 1.

11. The security support as claimed in claim 10, in which the security element is in the form of a thread which is at least partially incorporated in a security support with the at least partially visible first and second optical structures.

12. The security support as claimed in claim 10, in which the security element is in the form of a strip or of a patch applied to a surface of the support.

13. The security support as claimed in claim 10, in which the security element is in the form of a strip and exhibits a width of between 6 and 20 mm.

14. A security document, such as a passport, an identity card, a driving license, an interactive trading card, a means of payment, a credit card, a voucher, a travel pass, a loyalty card, a provision card or a season ticket, including a security element as claimed in claim 1

15. A security element for incorporating in or on a security document, comprising:
at least one first optical structure of the standard rainbow holography type and/or of the raster image type representing a first pattern,
at least one second optical structure which is achromatic and represents a second pattern at least partially identical to the first pattern, the second optical structure reproducing the second pattern in three dimensions.

16. The security element as claimed in claim 14, in which the first structure of the standard rainbow holography type is an optically variable diffractive structure.

17. The security element as claimed in claim 14, in which the raster image of said first optical structure comprises a plurality of points representing said first pattern.

18. The security element as claimed in claim 14, in which the first optical structure comprises a raster image, the points of which are obtained by perforation, deposition and/or voids of materials, selected from: metals, metal compounds, alloys, metal varnishes or metal inks.

19. The security element as claimed in claim 14, in which the first optical structure and the second optical structure are positioned on the security element in an adjacent fashion so as to be observable simultaneously and to be able to be compared.

20. The security element as claimed in claim 14, in which the first optical structure and the second optical structure are positioned on the security element and are separated by a distance of less than seven centimeters, so as to be observable simultaneously and to be able to be compared.

21. The security element as claimed in claim 14, in which said at least one first optical structure comprises a first reflecting layer and said at least one second optical structure comprises a second reflecting layer, the reflecting layers being composed of different materials.

22. The security element as claimed in claim 14, said at least one second achromatic optical structure being distinct from an optical structure of the raster image type.

23. A security support composed of natural fibrous materials, and/or of synthetic fibers, comprising at least one security element as claimed in claim 14.

24. The security support as claimed in claim 22, in which the security element exists in the form of a thread which is at least partially incorporated in the security support with the at least partially visible first and second optical structures.

25. The security support as claimed in claim 22, in which the security element exists in the form of a strip or of a patch applied to a surface of the support.

26. The security support as claimed in claim 22, in which the security element is in the form of a strip and exhibits a width of between 6 and 20 mm.

27. A security document, such as a passport, an identity card, a driving license, an interactive trading card, a means of payment including a security element as claimed in claim 14.
